(19) United States
(12) Patent Application Publication
(10) Pub. No.: US 2007/0029755 A1
(43) Pub. Date: Feb. 8, 2007

(54) UTILITY VEHICLE

(76) Inventors: MICHEL LAGACE, Magog (CA); ERIC CARBONNEAU, Ste-Foy (CA); BENOIT DROLET, St-Nicolas (CA)

Correspondence Address: GOUDREAU GAGE DUBUC, 800 PLACE VICTORIA, SUITE 3400, MONTREAL, QUEBEC, H4Z 1E9, CA

(21) Appl. No.: 11/462,757

(22) Filed: Aug. 7, 2006

Related U.S. Application Data
(60) Provisional application No. 60/705,463, filed on Aug. 5, 2005.

(51) Int. Cl. B62D 13/00

(52) U.S. Cl. 280/442; 280/444

(57) ABSTRACT

A utility vehicle equipped with a steering and suspension system wherein the direction pivot point is centered and positioned as close as possible to the pivot point of the suspension, and the assembly point of the wheel pivot is centered, to significantly reduce the effect of uneven ground surface, which causes the wheels to turn to the left or to the right when rolling up a bump or rolling down a crevasse. The suspension system provides complete independence for each wheel.

### CROSS REFERENCE TO RELATED APPLICATIONS

This application is a claims priority on U.S. provisional application No. 60/705,463, filed on Aug. 5, 2005. All documents above are herein incorporated by reference.

### FIELD OF THE INVENTION

The present invention relates to utility vehicles. More specifically, the present invention is concerned with vehicles used in agriculture and industry, such as feeders, tankers and utility vehicles for example.

### BACKGROUND OF THE INVENTION

4- 6 and 8-wheels spreader tankers with a tandem or hydraulic fixed suspension system are commonly used, combined with a hydraulic steering, a gear-based steering or a mechanical steering system.

As illustrated in FIG. 1 the appended drawings, a spreader tank 10 typically comprises an undercarriage supported by wheels, for carrying a tank or container 12 for example.

However such currently available vehicles with tandem suspension system are found to be less reliable in extreme terrain conditions, and represent a technological barrier to upgrade to 8 wheels for example. When combined with mechanical steering system, these vehicles are furthermore affected by the uneven grounds on which they travel.

### SUMMARY OF THE INVENTION

There is provided a utility vehicle, comprising an undercarriage supported by wheels; a steering system comprising direction rods extending from a front of the vehicle and distributing direction to the wheels; and a suspension, connecting a frame of the undercarriage with axles of the wheels; wherein a direction pivot point is centered and positioned as close as possible to a pivot point of the suspension, and an assembly point of each wheel pivot is centered.

There is provided a vehicle having a suspension system and a mechanical steering system, the steering system comprising direction rods extending from a front of the vehicle and distributing direction to wheels of the vehicle, the suspension system having a suspension pivot point; the steering system having a direction pivot point, and each wheel of the vehicle having a, wherein the direction pivot point is positioned as close as possible to the suspension pivot point and assembly points of wheels pivots are centered.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1, labelled as “prior art”, shows a 4-wheel tanker as known in the art;

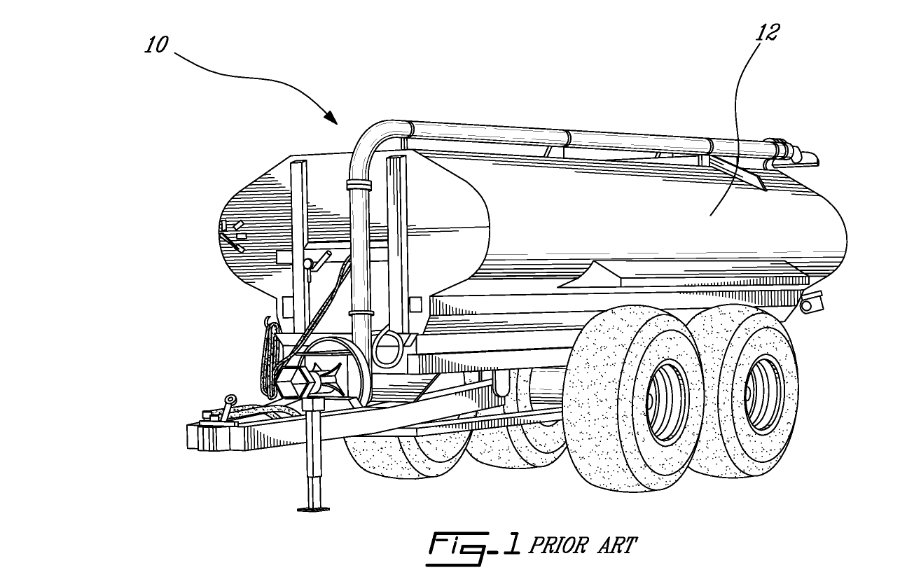

FIG. 2 shows the undercarriage, suspension system and steering system of a spreader tanker according to an embodiment of the present invention; and

FIG. 3 is a close-up of the suspension system and steering system of the spreader tanker of FIG. 2.

### DESCRIPTION OF EMBODIMENTS OF THE INVENTION

There is provided a utility vehicle, such as a spreader tanker discussed herein for illustrative purposes, having a suspension independent from the wheels and a mechanical steering system.

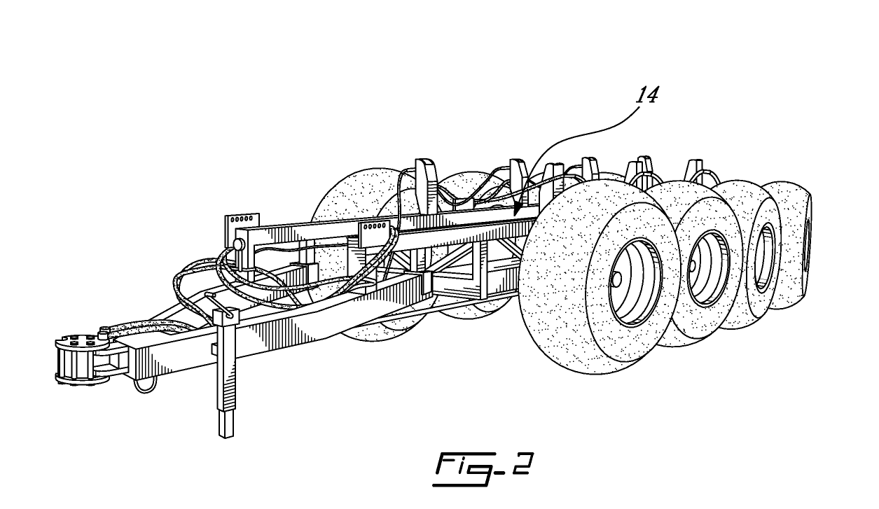

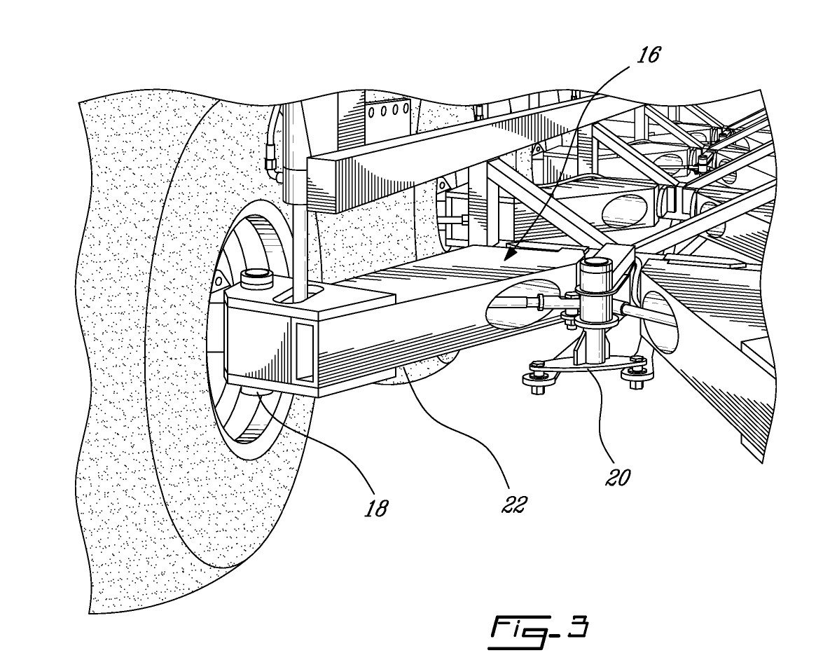

As seen in FIGS. 2 and 3, a vehicle according to the present invention uses a steering system comprising direction rods 14, extending from the front of the vehicle and distributing the direction to all wheels, which allows an adequate deflection angle of the wheels, different for the inner and the outer wheels depending on a radius of the turn of the path followed by the vehicle.

It is found that the location of the direction rods pivot 20 in relation to the suspension, by centering and positioning the direction pivot point 20 as close as possible to the pivot point of the suspension 22, and centering the assembly point of a wheel pivot 18, the effect of uneven relief of the ground surface whereby the wheel turns to the left or to the right when rolling up a bump or rolling down a crevasse, is significantly reduced.

The undercarriage may be of a modular type, i.e. it may be disassembled into members thereof, thereby allowing a quick and easy removal of the tank, in the illustrated example of a tanker, or allowing changing the length thereof to accommodate a variety of tanks, containers or other modules as a function of the load on the pull rod. The undercarriage may accommodate 4, 6 and 8 wheels.

In the illustrated case of a tanker, the tank or container may be unloaded by gravity at the rear of the vehicle. The loading of the tank may be achieved using simple and effective means such as a winch system.

The present vehicle therefore significantly reduces effects of uneven grounds on the mechanical steering system, while providing independent suspension for each wheel.

The present vehicle is safe and maneuverable on all types of terrains.

Although the present invention has been described hereinabove by way of embodiments thereof, it may be modified, without departing from the nature and teachings of the subject invention as defined in the appended claims.

What is claimed is:

1. A utility vehicle, comprising:
an undercarriage supported by wheels;
a steering system comprising direction rods extending from a front of the vehicle and distributing direction to the wheels; and
a suspension, connecting a frame of the undercarriage with axles of the wheels;
wherein a direction pivot point is centered and positioned as close as possible to a pivot point of the suspension, and an assembly point of each wheel pivot is centered.

2. The utility vehicle of claim 1, wherein said undercarriage accommodates 4, 5 or 8 wheels.

3. The utility vehicle of claim 1, wherein said undercarriage is of a modular type.

4. The utility vehicle of claim 1, wherein said undercarriage carries at least one of: i) tanks and ii) containers.

5. The utility vehicle of claim 1, wherein said suspension is independent from the wheels.

6. A vehicle having a suspension system and a mechanical steering system, said steering system comprising direction rods extending from a front of the vehicle and distributing direction to wheels of the vehicle, said suspension system having a suspension pivot point; said steering system having a direction pivot point, and each wheel of the vehicle having a, wherein said direction pivot point is positioned as close as possible to said suspension pivot point and assembly points of wheels pivots are centered.

7. The vehicle of claim 6, wherein said suspension is independent from the wheels.
